(19) United States
(12) Patent Application Publication
(10) Pub. No.: US 2026/0368741 A1
(43) Pub. Date: Nov. 19, 2026

(54) System, Method, and Computer Program Product for Determining a Dynamic Interchange Value Based on a Blockchain Network

(71) Applicant: Visa International Service Association, San Francisco, CA (US)

(72) Inventors: Mahesh Joshi, Hillsborough, CA (US); Arnab Dutta, Sunnyvale, CA (US); Venkata Gangadhar Rao Y, Karnataka (IN); Nishant Chandra, Karnataka (IN)

(21) Appl. No.: 19/141,164

(22) PCT Filed: Dec. 21, 2023
(86) PCT No.: PCT/US2023/085503

§ 371 Date: Jun. 19, 2025

Related U.S. Application Data
(60) Provisional application No. 63/434,959, filed on Dec. 23, 2022.

(51) Int. Cl. G06Q 20/40

(52) U.S. Cl. CPC G06Q 20/405; G06Q 20/4016; G06Q 2220/00

(57) ABSTRACT

Systems, methods, and computer program products for providing a dynamic interchange value based on a blockchain network. The system includes at least one processor configured to store account holder profile data for each account holder at a unique blockchain address, store merchant profile data for each merchant of a plurality of merchants at a unique blockchain address, receive a transaction request message for a first transaction comprising an account identifier, identify first account holder profile data from the account holder profile data stored in the blockchain network based on the account identifier, identify first merchant profile data from the merchant profile data stored in the blockchain network based on the first merchant, determine a dynamic interchange fee value based on the first merchant profile data and the first account holder profile data, and process the first transaction based on the dynamic interchange fee value.

### CROSS-REFERENCE TO RELATED APPLICATIONS

This application is the United States national phase of International Application No. PCT/US23/85503 filed Dec. 21, 2023, and claims priority to U.S. Provisional Patent Application No. 63/434,959, filed Dec. 23, 2022, the disclosures of which are hereby incorporated by reference in their entireties.

### BACKGROUND

### 1. Technical Field

The present disclosure relates generally to blockchain networks and, in some non-limiting aspects or embodiments, to systems, methods, and computer program products for determining a dynamic interchange value based on a blockchain network.

### 2. Technical Considerations

Interchange fees (e.g., “Merchant Discount Rate” or other fees charged to process transactions) have been under tremendous pressure worldwide. Various regulations and risk exposures make it difficult for payment processing networks to operate and achieve market penetration and large scale adoption of electronic payments. Moreover, interchange fees have been a barrier for card payments to achieve traction in the business-to-business sector.

### SUMMARY

Accordingly, provided are improved systems, methods, and computer program products for determining a dynamic interchange value based on a blockchain network.

According to non-limiting embodiments or aspects, provided is a system for determining a dynamic interchange value based on a blockchain network. The system includes at least one processor configured to store account holder profile data for each account holder of a plurality of account holders at a unique blockchain address in a blockchain network. The at least one processor is also configured to store merchant profile data for each merchant of a plurality of merchants at a unique blockchain address in the blockchain network. The at least one processor is further configured to receive, from a merchant system associated with a first merchant, a transaction request message for a first transaction including an account identifier. The at least one processor is further configured to identify first account holder profile data from the account holder profile data stored in the blockchain network based on the account identifier. The at least one processor is further configured to identify first merchant profile data from the merchant profile data stored in the blockchain network based on the first merchant. The at least one processor is further configured to determine a dynamic interchange fee value based on the first merchant profile data and the first account holder profile data. The at least one processor is further configured to process the first transaction based on the dynamic interchange fee value.

In some non-limiting embodiments or aspects, the at least one processor may be further configured to generate a non-fungible token for each account holder of the plurality of account holders, each non-fungible token for each account holder including the account holder profile data or a pointer to the account holder profile data for a corresponding account holder. The at least one processor may be further configured to generate a non-fungible token for each merchant of the plurality of merchants, each non-fungible token for each merchant including the merchant profile data or a pointer to the merchant profile data for a corresponding merchant. In some non-limiting embodiments or aspects, the at least one processor may be further configured to generate a machine-readable code based on a non-fungible token for a first account holder associated with the first account holder profile data. In some non-limiting embodiments or aspects, the at least one processor may be further configured to generate a machine-readable code based on a non-fungible token for the first merchant based on a merchant location identifier corresponding to the first merchant.

In some non-limiting embodiments or aspects, the first account holder profile data and the first merchant profile data may be identified before receiving the transaction request message. The at least one processor may be further configured to generate at least one database external to the blockchain network, the at least one database including the account holder profile data for the plurality of account holders and the merchant profile data for the plurality of merchants retrieved from the blockchain network. The at least one processor may be further configured to, in response to receiving the transaction request message, query the at least one database based on the first merchant and the account identifier to obtain the first merchant profile data and the first account holder profile data. In some non-limiting embodiments or aspects, the first account holder profile data and the first merchant profile data may be stored in at least one database arranged external to the blockchain network. The account holder profile data stored in the blockchain network may include pointers to the first account holder profile data and a second account holder profile data in the at least one database.

In some non-limiting embodiments or aspects, the first merchant profile data may include at least one of the following: a risk score for the first merchant, a risk score for an acquirer system corresponding to the first merchant, or any combination thereof. In some non-limiting embodiments or aspects, the first account holder profile data may include at least one of the following: a risk score for a first account holder, a risk score for a first account, a risk score for an issuer system corresponding to the first account holder, a risk score for a credit union corresponding to the first account holder, or any combination thereof. In some non-limiting embodiments or aspects, the at least one processor may be further configured to generate an authorization request message including the dynamic interchange fee value. The at least one processor may be further configured to communicate the authorization request message to an issuer system corresponding to a first account holder associated with the first account holder profile data.

According to non-limiting embodiments or aspects, provided is a method for determining a dynamic interchange value based on a blockchain network. The method includes storing account holder profile data for each account holder of a plurality of account holders at a unique blockchain address in a blockchain network. The method also includes storing merchant profile data for each merchant of a plurality of merchants at a unique blockchain address in the blockchain network. The method further includes receiving, from a merchant system associated with a first merchant, a transaction request message for a first transaction including an account identifier. The method further includes identifying, with at least one processor, first account holder profile data from the account holder profile data stored in the blockchain network based on the account identifier. The method further includes identifying, with at least one processor, first merchant profile data from the merchant profile data stored in the blockchain network based on the first merchant. The method further includes determining, with at least one processor, a dynamic interchange fee value based on the first merchant profile data and the first account holder profile data; and processing, with at least one processor, the first transaction based on the dynamic interchange fee value.

In some non-limiting embodiments or aspects, the method may further include generating a non-fungible token for each account holder of the plurality of account holders, each non-fungible token for each account holder including the account holder profile data or a pointer to the account holder profile data for a corresponding account holder. The method may further include generating a non-fungible token for each merchant of the plurality of merchants, each non-fungible token for each merchant including the merchant profile data or a pointer to the merchant profile data for a corresponding merchant. In some non-limiting embodiments or aspects, the method may further include generating a machine-readable code based on a non-fungible token for a first account holder associated with the first account holder profile data. In some non-limiting embodiments or aspects, the method may further include generating a machine-readable code based on a non-fungible token for the first merchant based on a merchant location identifier corresponding to the first merchant.

In some non-limiting embodiments or aspects, the first account holder profile data and the first merchant profile data may be identified before receiving the transaction request message. The method may further include generating at least one database external to the blockchain network, the at least one database including the account holder profile data for the plurality of account holders and the merchant profile data for the plurality of merchants retrieved from the blockchain network. The method may further include, in response to receiving the transaction request message, querying the at least one database based on the first merchant and the account identifier to obtain the first merchant profile data and the first account holder profile data. In some non-limiting embodiments or aspects, the first account holder profile data and the first merchant profile data may be stored in at least one database arranged external to the blockchain network. The account holder profile data stored in the blockchain network may include pointers to the first account holder profile data and a second account holder profile data in the at least one database.

In some non-limiting embodiments or aspects, the first merchant profile data may include at least one of the following: a risk score for the first merchant, a risk score for an acquirer system corresponding to the first merchant, or any combination thereof. In some non-limiting embodiments or aspects, the first account holder profile data may include at least one of the following: a risk score for a first account holder, a risk score for a first account, a risk score for an issuer system corresponding to a first account holder, a risk score for a credit union corresponding to the first account holder, or any combination thereof. In some non-limiting embodiments or aspects, the method may further include generating an authorization request message including the dynamic interchange fee value. The method may further include communicating the authorization request message to an issuer system corresponding to a first account holder associated with the first account holder profile data.

According to non-limiting embodiments or aspects, provided is a computer program product for determining a dynamic interchange value based on a blockchain network. The computer program product includes at least one non-transitory computer-readable medium including program instructions that, when executed by at least one processor, cause the at least one processor to store account holder profile data for each account holder of a plurality of account holders at a unique blockchain address in a blockchain network. The program instructions also cause the at least one processor to store merchant profile data for each merchant of a plurality of merchants at a unique blockchain address in the blockchain network. The program instructions further cause the at least one processor to receive, from a merchant system associated with a first merchant, a transaction request message for a first transaction including an account identifier. The program instructions further cause the at least one processor to identify first account holder profile data from the account holder profile data stored in the blockchain network based on the account identifier. The program instructions further cause the at least one processor to identify first merchant profile data from the merchant profile data stored in the blockchain network based on the first merchant. The program instructions further cause the at least one processor to determine a dynamic interchange fee value based on the first merchant profile data and the first account holder profile data. The program instructions further cause the at least one processor to process the first transaction based on the dynamic interchange fee value.

In some non-limiting embodiments or aspects, the program instructions may further cause the at least one processor to generate a non-fungible token for each account holder of the plurality of account holders, each non-fungible token for each account holder including the account holder profile data or a pointer to the account holder profile data for a corresponding account holder. The program instructions may further cause the at least one processor to generate a non-fungible token for each merchant of the plurality of merchants, each non-fungible token for each merchant including the merchant profile data or a pointer to the merchant profile data for a corresponding merchant.

Further non-limiting embodiments or aspects are set forth in the following numbered clauses:

Clause 1: A system comprising: at least one processor configured to: store account holder profile data for each account holder of a plurality of account holders at a unique blockchain address in a blockchain network; store merchant profile data for each merchant of a plurality of merchants at a unique blockchain address in the blockchain network; receive, from a merchant system associated with a first merchant, a transaction request message for a first transaction comprising an account identifier; identify first account holder profile data from the account holder profile data stored in the blockchain network based on the account identifier; identify first merchant profile data from the merchant profile data stored in the blockchain network based on the first merchant; determine a dynamic interchange fee value based on the first merchant profile data and the first account holder profile data; and process the first transaction based on the dynamic interchange fee value.

Clause 2: The system of clause 1, wherein the at least one processor is further configured to: generate a non-fungible token for each account holder of the plurality of account holders, each non-fungible token for each account holder comprising the account holder profile data or a pointer to the account holder profile data for a corresponding account holder; and generate a non-fungible token for each merchant of the plurality of merchants, each non-fungible token for each merchant comprising the merchant profile data or a pointer to the merchant profile data for a corresponding merchant.

Clause 3: The system of clause 1 or 2, wherein the at least one processor is further configured to generate a machine-readable code based on a non-fungible token for a first account holder associated with the first account holder profile data.

Clause 4: The system of any of clauses 1-3, wherein the at least one processor is further configured to generate a machine-readable code based on a non-fungible token for the first merchant based on a merchant location identifier corresponding to the first merchant.

Clause 5: The system of any of clauses 1-4, wherein the first account holder profile data and the first merchant profile data are identified before receiving the transaction request message, the at least one processor further configured to: generate at least one database external to the blockchain network, the at least one database comprising the account holder profile data for the plurality of account holders and the merchant profile data for the plurality of merchants retrieved from the blockchain network; and in response to receiving the transaction request message, query the at least one database based on the first merchant and the account identifier to obtain the first merchant profile data and the first account holder profile data.

Clause 6: The system of any of clauses 1-5, wherein the first account holder profile data and the first merchant profile data are stored in at least one database arranged external to the blockchain network, wherein the account holder profile data stored in the blockchain network comprises pointers to the first account holder profile data and a second account holder profile data in the at least one database.

Clause 7: The system of any of clauses 1-6, wherein the first merchant profile data comprises at least one of the following: a risk score for the first merchant, a risk score for an acquirer system corresponding to the first merchant, or any combination thereof.

Clause 8: The system of any of clauses 1-7, wherein the first account holder profile data comprises at least one of the following: a risk score for a first account holder, a risk score for a first account, a risk score for an issuer system corresponding to the first account holder, a risk score for a credit union corresponding to the first account holder, or any combination thereof.

Clause 9: The system of any of clauses 1-8, the at least one processor further configured to: generate an authorization request message comprising the dynamic interchange fee value; and communicate the authorization request message to an issuer system corresponding to a first account holder associated with the first account holder profile data.

Clause 10: A method comprising: storing account holder profile data for each account holder of a plurality of account holders at a unique blockchain address in a blockchain network; storing merchant profile data for each merchant of a plurality of merchants at a unique blockchain address in the blockchain network; receiving, from a merchant system associated with a first merchant, a transaction request message for a first transaction comprising an account identifier; identifying, with at least one processor, first account holder profile data from the account holder profile data stored in the blockchain network based on the account identifier; identifying, with at least one processor, first merchant profile data from the merchant profile data stored in the blockchain network based on the first merchant; determining, with at least one processor, a dynamic interchange fee value based on the first merchant profile data and the first account holder profile data; and processing, with at least one processor, the first transaction based on the dynamic interchange fee value.

Clause 11: The method of clause 10, further comprising: generating a non-fungible token for each account holder of the plurality of account holders, each non-fungible token for each account holder comprising the account holder profile data or a pointer to the account holder profile data for a corresponding account holder; and generating a non-fungible token for each merchant of the plurality of merchants, each non-fungible token for each merchant comprising the merchant profile data or a pointer to the merchant profile data for a corresponding merchant.

Clause 12: The method of clause 10 or 11, further comprising generating a machine-readable code based on a non-fungible token for a first account holder associated with the first account holder profile data.

Clause 13: The method of any of clauses 10-12, further comprising generating a machine-readable code based on a non-fungible token for the first merchant based on a merchant location identifier corresponding to the first merchant.

Clause 14: The method of any of clauses 10-13, wherein the first account holder profile data and the first merchant profile data are identified before receiving the transaction request message, the method further comprising: generating at least one database external to the blockchain network, the at least one database comprising the account holder profile data for the plurality of account holders and the merchant profile data for the plurality of merchants retrieved from the blockchain network; and in response to receiving the transaction request message, querying the at least one database based on the first merchant and the account identifier to obtain the first merchant profile data and the first account holder profile data.

Clause 15: The method of any of clauses 10-14, wherein the first account holder profile data and the first merchant profile data are stored in at least one database arranged external to the blockchain network, wherein the account holder profile data stored in the blockchain network comprises pointers to the first account holder profile data and a second account holder profile data in the at least one database.

Clause 16: The method of any of clauses 10-15, wherein the first merchant profile data comprises at least one of the following: a risk score for the first merchant, a risk score for an acquirer system corresponding to the first merchant, or any combination thereof.

Clause 17: The method of any of clauses 10-16, wherein the first account holder profile data comprises at least one of the following: a risk score for a first account holder, a risk score for a first account, a risk score for an issuer system corresponding to a first account holder, a risk score for a credit union corresponding to the first account holder, or any combination thereof.

Clause 18: The method of any of clauses 10-17, further comprising: generating an authorization request message comprising the dynamic interchange fee value; and communicating the authorization request message to an issuer system corresponding to a first account holder associated with the first account holder profile data.

Clause 19: A computer program product comprising at least one non-transitory computer-readable medium including program instructions that, when executed by at least one processor, cause the at least one processor to: store account holder profile data for each account holder of a plurality of account holders at a unique blockchain address in a blockchain network; store merchant profile data for each merchant of a plurality of merchants at a unique blockchain address in the blockchain network; receive, from a merchant system associated with a first merchant, a transaction request message for a first transaction comprising an account identifier; identify first account holder profile data from the account holder profile data stored in the blockchain network based on the account identifier; identify first merchant profile data from the merchant profile data stored in the blockchain network based on the first merchant; determine a dynamic interchange fee value based on the first merchant profile data and the first account holder profile data; and process the first transaction based on the dynamic interchange fee value.

Clause 20: The computer program product of clause 19, wherein the program instructions further cause the at least one processor to: generate a non-fungible token for each account holder of the plurality of account holders, each non-fungible token for each account holder comprising the account holder profile data or a pointer to the account holder profile data for a corresponding account holder; and generate a non-fungible token for each merchant of the plurality of merchants, each non-fungible token for each merchant comprising the merchant profile data or a pointer to the merchant profile data for a corresponding merchant.

These and other features and characteristics of the presently disclosed subject matter, as well as the methods of operation and functions of the related elements of structures and the combination of parts and economies of manufacture, will become more apparent based on the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a schematic diagram of a system for determining a dynamic interchange value based on a blockchain network, according to some non-limiting aspects or embodiments;

FIG. 2 is a schematic diagram of a system for determining a dynamic interchange value based on a blockchain network, according to some non-limiting aspects or embodiments;

FIG. 3 is a flow diagram of a method for determining a dynamic interchange value based on a blockchain network, according to some non-limiting aspects or embodiments; and

FIG. 4 is a schematic diagram of components of one or more devices of FIG. 1, according to some non-limiting aspects or embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the terms “issuer,” “issuer institution,” “issuer bank,” or “payment device issuer” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, “issuer system” may refer to one or more computer systems operated by or on behalf of an issuer, such as a server executing one or more software applications. For example, an issuer system may include one or more authorization servers for authorizing a transaction.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, “merchant system” may refer to one or more computer systems operated by or on behalf of a merchant, such as a server executing one or more software applications. As used herein, the term “product” may refer to one or more goods and/or services offered by a merchant.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, “transaction processing system” may refer to one or more computer systems operated by or on behalf of a transaction service provider, such as a transaction processing server executing one or more software applications. A transaction processing system may include one or more processors and, in some non-limiting embodiments, may be operated by or on behalf of a transaction service provider.

Provided are systems, methods, and computer program products for determining a dynamic interchange value, such as an interchange fee to be charged to process a payment transaction, based on a blockchain network. Non-limiting embodiments described herein provide for a unique arrangement of system components in a blockchain network to enable a transaction processing system to dynamically determine an interchange fee (e.g., interchange value) based on data sources that may change over time. Non-limiting embodiments enable transaction processing systems to determine a dynamic interchange fee without having to maintain and manage multiple disparate data sources for merchants, banks, accounts, and/or account holders, thereby making such transaction processing systems more efficient and utilizing less processing resources in determining a dynamic value and/or processing a transaction. Various other advantages and improvements are described herein.

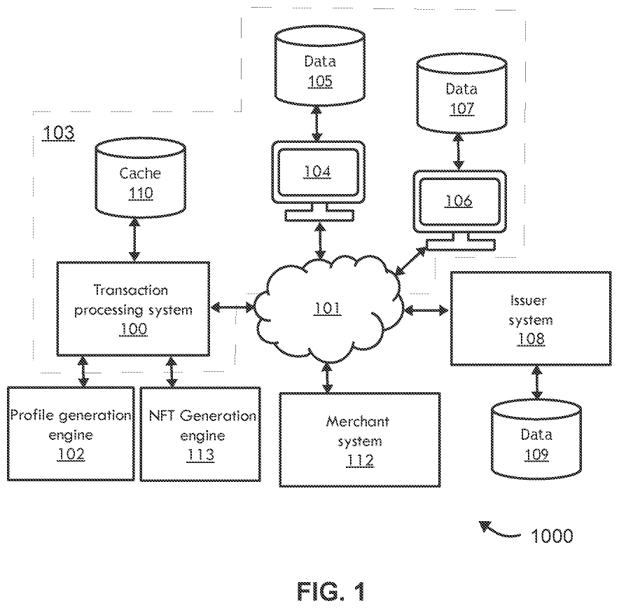

Referring to FIG. 1, illustrated is a diagram of a system 1000 for determining a dynamic interchange value, such as an interchange fee to be charged to process a payment transaction, based on a blockchain network 103. As illustrated in FIG. 1, the system 1000 includes a transaction processing system 100, merchant system 112, issuer system 108, and a network environment 101 (e.g., public and/or private networks, such as the Internet, a payment network, and/or the like) through which the systems communicate. Other computing devices 104, 106 are also in communication with the network environment 101. A blockchain network 103 includes at least a portion of computing devices, including the transaction processing system 100, computing device 104, and computing device 106. The blockchain network 103 includes computing devices that participate in and/or operate as a node (e.g., maintain a distributed ledger and/or other function) in the blockchain network 103. The systems in the blockchain network 103 may be in communication via the Internet, as an example, and may implement one or more blockchain protocols and/or applications for interacting with the other systems and/or the distributed ledgers maintained by such systems in the blockchain network 103. Data storage devices 105, 107 may include a distributed ledger that logs blockchain transactions, such as associating blockchain addresses with assets (e.g., tokens, such as but not limited to non-fungible tokens) and/or other data.

Although the merchant system 112 and issuer system 108 are shown in FIG. 1 to be external to the blockchain network 103, it will be appreciated that the one or more merchant systems (including merchant system 112) and/or one or more issuer systems (including issuer system 108) may be participants in and/or operate as a node within the blockchain network 103. Moreover, computing systems 104, 106 and/or other computing devices in the blockchain network 103 may include issuer systems, acquirer systems, merchant systems, payment gateway systems, and/or the like. In some non-limiting embodiments, entities in a payment processing network such as merchant system 112 and/or issuer system 108 may store profile data (e.g., data used to generate profiles and/or profiles that have already been generated). For example, issuer system 108 may be in communication with a data storage device including transaction data 109 for that issuer system 108. The transaction data 109 may include records for transactions authorized by the issuer system 108 and/or profile data for one or more accounts and/or account holders associated with the issuer.

With continued reference to FIG. 1, the transaction processing system 100 may retrieve merchant data, account data, and/or account holder data from the blockchain network 103 and store it in a cache 110. The cache 110 may be memory stored on one or more data storage devices and may be local or remote to the transaction processing system 100. The transaction processing system 100 may update the cache 110 at regular intervals (e.g., once a day, twice a day, once a week, and/or the like) and/or in response to an event (e.g., a request, a scheduled update, and/or the like). Updating the cache may include replacing the cache 110 memory with new data and/or replacing or adding one or more additional data records to the cache 110 memory.

A profile generation engine 102 may be local or remote to the transaction processing system 100. The profile generation engine 102 may include software executing on one or more computing devices. The profile generation engine 102 may be part of the transaction processing system 100 or may be a separate system. The profile generation engine 102 may generate an account profile, account holder profile, issuer profile, merchant profile, acquirer profile, and/or other profiles for various entities in a payment processing network. In some non-limiting embodiments or aspects, the profile generation engine 102 may generate risk profiles that represent, for example, a predicted risk level for an entity. In some non-limiting embodiments or aspects, the profile generation engine 102 may generate one or more profiles based on data stored in the cache 110. In some non-limiting embodiments or aspects, risk profiles may include, or may be used to determine, one or more risk scores for an entity (e.g., an account holder risk score, account risk score, issuer risk score, merchant risk score, acquirer risk score, and/or the like). In some non-limiting embodiments or aspects, the profile generation engine 102 may include multiple profile generation engines including at least one profile generation engine for each type of profile (e.g., account holder profile, issuer profile, merchant profile, and/or the like).

In some non-limiting embodiments or aspects, the transaction processing system 100 may receive a transaction request message that originates from the merchant system 112 in response to an account holder (not shown in FIG. 1) initiating a transaction using a payment device corresponding to an account (e.g., account identifier). In response to receiving the transaction request message, the transaction processing system 100 may determine if a profile for the account holder, account identifier, issuer system that issued the account, merchant, and/or acquirer system corresponding to the merchant is already stored in the cache 110 or another data source (e.g., an off-chain data source external to the blockchain network 103). Various profiles may be used. In some examples, an account holder profile, account profile, and/or merchant profile may be determined based on stored data. If the profiles do not already exist or are outdated, the transaction processing system may retrieve account data, account holder data, and merchant data from the cache 110 that was previously obtained from the blockchain network 103. The profile generation engine 102 may then generate one or more profiles.

After receiving the profiles from the profile generation engine 102, the transaction processing system 100 may determine a dynamic interchange fee based on one or more algorithms that use, as input, one or more profiles and/or risk scores associated therewith. For example, an interchange fee may be determined as a function of an account risk score, account holder risk score, and merchant risk score. The risk scores may be determined by one or more risk models based on parameters from the profiles. Risk scoring systems (not shown in FIG. 1) may be internal or external to the transaction processing system 100 and/or issuer system 108. After being generated, the dynamic interchange fee may be communicated to the merchant system 112, acquirer system, and/or issuer system 108. In some non-limiting embodiments or aspects, a service (e.g., a data retrieval service) may retrieve and/or determine the dynamic interchange fee upon request (e.g., in response to a request message, in response to an Application Programming Interface (API) query, and/or the like). In some non-limiting embodiments or aspects, the dynamic interchange fee may be communicated to an issuer system 108 corresponding to an issuer institution that issued the account being used for the transaction. In some examples, the dynamic interchange fee may be included in an authorization request message that is sent to the issuer system 108.

With continued reference to FIG. 1, a non-fungible token (NFT) generation engine 113 may be local or remote to the transaction processing system 100. The NFT generation engine 113 may include software executing on one or more computing devices. The NFT generation engine 113 may be part of the transaction processing system 100 or may be a separate system. The NFT generation engine 113 may generate one or more NFTs. For example, the NFT generation engine 113 may generate an account NFT based on an account, an account holder, an entity, a merchant, and/or the like. In some non-limiting embodiments or aspects, the NFT generation engine 113 uses account credentials (e.g., account identifier, billing information, account holder, and/or the like) to generate an NFT based on NFT data, which may include one or more digital media files, such as images, videos, text, and/or audio. In some non-limiting embodiments or aspects, the NFT generation engine 113 mints NFT data on the blockchain network 103. Each NFT may be minted on the blockchain and associated with a blockchain address (e.g., digital wallet address) corresponding to the account, account holder, and/or other entity. In some non-limiting embodiments or aspects, the NFT generation engine 113 may include multiple NFT generation engines including at least one NFT generation engine for each type of NFT (e.g., account holder NFT, issuer NFT, merchant NFT, and/or the like).

In some non-limiting embodiments or aspects, the NFT generation engine 113 may generate one or more merchant NFTs using merchant data, such as merchant identifiers, merchant location identifiers (e.g., Visa Store ID (VSID) or the like). Each NFT may be minted on the blockchain and associated with a blockchain address (e.g., digital wallet address) corresponding to the merchant system, acquirer, and/or the like. In some examples, the NFT data used to generate the NFTs may include data from a Global Merchant Repository. In some non-limiting embodiments or aspects, other types of NFTs may be generated. For example, a company NFT may be generated for commercial accounts (e.g., commercial cards) to reflect centrally billed accounts (e.g., accounts associated with an entity). In some non-limiting embodiments or aspects, the NFTs may be generated based on profile data.

The NFTs (e.g., account NFTs, account holder NFTs, merchant NFTs, etc.) may be used as identifiers by the associated entity. In some non-limiting embodiments or aspects, profile data (e.g., account holder profile data, account profile data, merchant profile data, acquirer profile data, issuer profile data, etc.) may be encrypted in an NFT. For example, account holder profile data and/or account profile data may be encrypted as the NFT data used to generate the NFT.

In some non-limiting embodiments or aspects, the NFTs are exposed in a permissions-based manner to entities in a payment processing network or outside such a network, such as an issuer institution, acquirer institution, credit bureau, credit union, third parties, and/or the like. The permissions associated with the NFTs and/or blockchain network 103 may permit authorized (e.g., permitted) parties to update profile data. For example, an issuer institution may have permission to update an account profile and/or account holder profile based on transactions and risk determinations. In some non-limiting embodiments or aspects, other parties such as acquirer systems, issuer systems, merchant systems, and/or third parties (e.g., such as credit bureaus) may have permission to update the profile data stored external to the blockchain network. Permissions may be based on parameter, type of profile, and/or the like.

In some non-limiting embodiments or aspects, a merchant profile may include merchant parameters such as, for example, a benchmark credit score (e.g., a score for a merchant location), authorization rates, chargeback rates, authorization/chargeback ratios, dispute rates, merchant identifier, acquirer identifier, coverage, consumption, completeness, transaction frequency, transaction history (e.g., time since the last transaction), and/or the like. The merchant parameters may be used to determine a merchant risk score and/or an acquirer risk score associated with the merchant. One or more risk scoring models may be used in non-limiting examples to process the merchant parameters and to determine a risk score.

In some non-limiting embodiments or aspects, an account profile and/or account holder profile may include account parameters such as, for example, spending pattern data, high risk merchant category codes (MCCs), authorization rate (e.g., a percentage or number of transactions that are authorized and/or not authorized), an authorization score (e.g., an advanced authorization score), chargeback data (e.g., a measure of transactions that have been disputed and resulted in a chargeback to credit the payor), dispute data (e.g., a percentage or number of transactions that are disputed), transaction frequency, transaction history (e.g., time since the last transaction), and/or the like. The account parameters may include and/or be used to determine an account risk score and/or an account holder risk score associated with the account and/or account holder. For example, an account holder risk score may be based on the account holder and one or more accounts, including an account being used, and an account risk score may relate to a specific account. One or more risk scoring models may be used in non-limiting examples to process the account parameters and to determine one or more risk scores. Other transaction data, in addition to and/or alternative to the account parameters, may be used to determine an issuer risk score, credit union risk score, account holder risk score, account risk score, a credit bureau risk score (e.g., Dun & Bradstreet (DnB) score), and/or the like.

In some non-limiting embodiments or aspects, a dynamic interchange value for an interchange fee is determined based on risk scores for the merchant and the account and/or account holder (e.g., multiple accounts associated with an entity). For example, a dynamic interchange value may be proportional to risk such that a lower risk is associated with a lower interchange value. If, for example, an account holder has a history of always paying in full and/or has sufficient funds, as determined from account parameters associated with the account holder and made available by an issuer system, the account holder may have a lower risk score than an account holder that does not have a positive payment history and/or sufficient funds. Likewise, if a merchant is in good standing, as determined from merchant parameters associated with a merchant account and made available by an acquirer system and/or transaction processing system, the merchant may have a lower risk score than a merchant that is not in good standing. The account holder risk score and/or merchant risk score may be used to determine a dynamic interchange value. For example, an algorithm may generate a dynamic interchange value by determining an offset value as a function of the risk scores that increases with the account holder risk score and merchant risk score and decreases with the account holder risk score and merchant risk score. The offset value may be added or subtracted from a set interchange value (e.g., an average interchange value, a predetermined interchange value, and/or the like).

In some non-limiting embodiments or aspects, the profile data (e.g., account profile, account holder profile, merchant profile, and/or profiles for any other entity or entities) may be stored in various locations on the blockchain network or off of the blockchain network. For example, in non-limiting embodiments in which the profile data is stored off of the blockchain network, it may be stored in a data storage device in communication with an issuer system, an acquirer system, a transaction processing system, a payment gateway system, and/or the like. The blockchain network may then store, for example on ledgers maintained by a plurality of nodes on a blockchain network, pointers to the profile data. For example, the blockchain network may store links to assets, including profile data, as network addresses associated with other systems in the blockchain network or in communication with the blockchain network. For example, in non-limiting embodiments an identifier internal to the transaction processing system may be mapped to a blockchain address and/or NFT, such as a Global Merchant Repository ID, a hashed account identifier or account holder identifier, and/or the like. In some non-limiting embodiments in which the profile data is stored on the blockchain network, it may be tokenized, encrypted, and/or compressed.

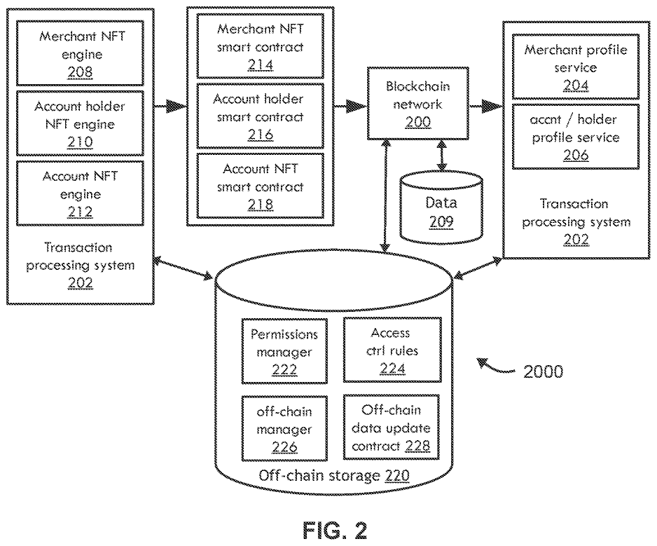

Referring now to FIG. 2, a system 2000 for generating a dynamic interchange value based on a blockchain network is shown according to some non-limiting embodiments and aspects. A transaction processing system 202 includes a merchant NFT engine 208, an account holder NFT engine 210, and an account NFT engine 212. The merchant NFT engine 208, account holder NFT engine 210, and account NFT engine 212 may operate similarly to the NFT generation engine 113 described in connection with FIG. 1. In some examples, an account holder NFT engine 210 comprises an account NFT engine 212 such that it takes into consideration account parameters and account holder parameters.

A blockchain network 200 may include a plurality of computing devices in communication through a network that operate as nodes in the network. Some computing devices in the blockchain network 200 may host a distributed ledger including blockchain data 209, which may include allocations of cryptographic tokens (e.g., cryptocurrency tokens or NFTs) to blockchain addresses, smart contracts associated with blockchain addresses, and/or the like. A merchant NFT smart contract 214, account holder smart contract 216, and account NFT smart contract 218 may each be smart contracts defining event-based rules for one or more blockchain addresses and/or nodes in the blockchain network. The smart contracts 214, 216, 218 may be used to generate the NFTs. For example, the smart contracts 214, 216, 218 may establish rules (e.g., such as conditions, entities, functions, and/or the like) that assign ownership (e.g., allocation to a blockchain address) and/or reassignment (e.g., transfer from one blockchain address to another) for the NFTs generated by the merchant NFT engine 208, account holder NFT engine 210, and account NFT engine 212 such that the NFTs can be minted on the blockchain network 200.

Still referring to FIG. 2, off-chain storage 220 may include one or more data storage devices external to the blockchain network 200. The off-chain storage 220 may be hosted and/or maintained by the transaction processing system 202, an issuer system (not shown in FIG. 2), a third-party service provider, and/or the like. The off-chain storage 220 may include a permissions manager 222, which may include software and/or structured data defining permissions that different entities have with respect to on-chain data access, off-chain data access, and/or blockchain network 200 functionality. The off-chain storage 220 may include access control rules 224, which may include structured data associating access control permissions and/or functions with parameters as logical rules. The off-chain storage 220 may include an off-chain manager 226, which may include software and/or structured data defining how off-chain data is accessed. The off-chain storage 220 may also include an off-chain data update contract 226.

With continued reference to FIG. 2, the transaction processing system 202 or another system may host a merchant profile service 204 and an account and/or account holder profile service 206. The merchant profile service and account and/or account holder profile service 206 may include one or more software applications executed by one or more computing devices to obtain a merchant profile, account profile, and/or account holder profile from the blockchain network 200 (e.g., from blockchain data 209 and/or from off-chain storage 220 via a pointer from the blockchain data 209). In some examples, the services 204, 206 may be accessible through one or more APIs and may collect data from one or more sources. For example, in non-limiting embodiments the merchant profile service 204 and the account and/or account holder profile service 206 may obtain parameters from one or more different sources and create a profile for use by the NFT engines 208, 210, 212. In some non-limiting embodiments or aspects, the merchant profile service 204 and an account and/or account holder profile service 206 may function as adapters to transform profile data, including NFT data, into attributes (e.g., parameters) that may be used in the electronic payment processing network (e.g., in risk scoring algorithms, for example).

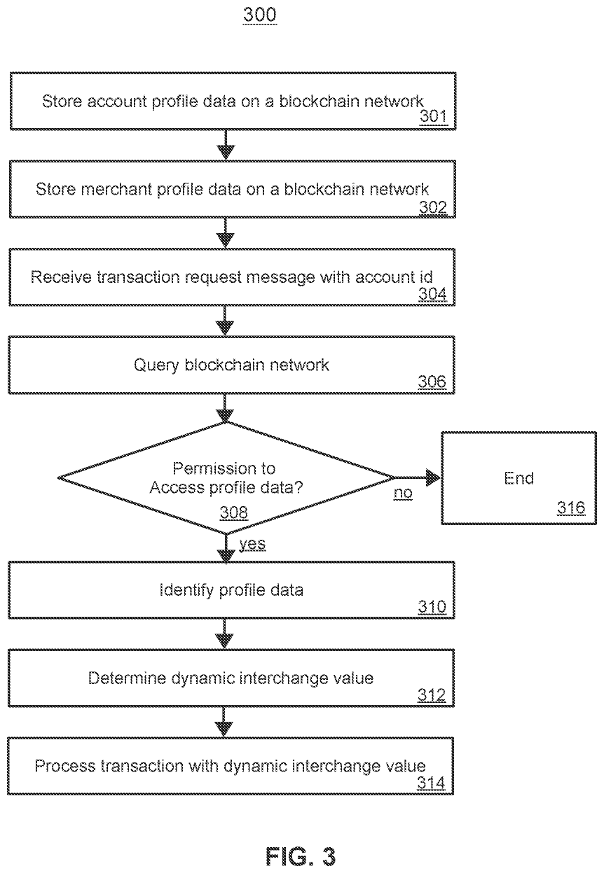

Referring now to FIG. 3, a flow diagram is shown for a process of generating a dynamic interchange value based on a blockchain network according to some non-limiting embodiments or aspects. The steps shown in FIG. 3 are for example purposes only. It will be appreciated that additional, fewer, different, and/or a different order of steps may be used in non-limiting embodiments or aspects. In some non-limiting embodiments or aspects, one or more of the steps of process 300 may be performed (e.g., completely, partially, and/or the like) by transaction processing system 100 or transaction processing system 202. In some non-limiting embodiments or aspects, one or more of the steps of process 300 may be performed (e.g., completely, partially, and/or the like) by another system, another device, another group of systems, or another group of devices, separate from or including transaction processing system 100 or transaction processing system 202.

As shown in FIG. 3, at step 301, process 300 may include storing account profile data on a blockchain network. For example, transaction processing system 202 may store account profile data on blockchain network 200.

As shown in FIG. 3, at step 302, process 300 may include storing merchant profile data on the blockchain network. For example, transaction processing system 202 may store merchant profile data on blockchain network 200. By way of further example, account holder profile data, account profile data, and/or merchant profile data may be stored at one or more blockchain addresses in a blockchain network. As an example, one or more blockchain addresses may store pointers to profile data that is stored off of the blockchain network (e.g., at a network location on a public or private network). In some examples, the profile data may be stored on the blockchain network, such as encrypted data stored on multiple nodes (e.g., computing devices participating in the blockchain network) and associated with one or more blockchain addresses.

In some non-limiting embodiments or aspects, after step 302, a transaction processing system may obtain the profile data from the blockchain network and store it in a cache, such as memory local to the transaction processing system. For example, periodically, at regular or dynamic intervals, and/or in response to an event, the blockchain may be queried (e.g., through one or more APIs or the like) for the profile data and store and/or update the cache with the obtained profile data. This allows for the profile data to be quickly accessed without querying the blockchain network, thereby allowing for use of the profile data during a real-time payment transaction without significant delay. As used herein, the term “real-time” may refer to performance of a task or tasks during another process or before another process is completed. For example, use of data during a real-time payment transaction may include access of the data, reference to data, retrieval of the data, analysis of the data, manipulation of the data, storage of the data, and/or the like, before an in-progress payment transaction is authorized, completed, and/or the like.

As shown in FIG. 3, at step 304, process 300 may include receiving a transaction request message. For example, transaction processing system 202 may receive the transaction request message. The transaction request message may be received from a merchant system and/or acquirer system, and may identify an account (e.g., account identifier) of an account holder requesting the transaction, a merchant identifier, a transaction value, and/or other transaction data. In some examples the transaction request message may originate from a merchant system, such as a point-of-sale (POS) system or web server, that initially processes a transaction initiated by an account holder (e.g., customer).

As shown in FIG. 3, at step 306, process 300 may include querying the blockchain network based on one or more parameters of the transaction data for the transaction request message received at step 304. For example, a blockchain network may be queried based on an account identifier and/or merchant identifier. Querying the blockchain may include sending a request message, for example through an API, to nodes in the blockchain network to retrieve information stored on one or more nodes. In some examples, a blockchain query may specify a key (e.g., such as a digital signature generated based on the requestor's private key). In some non-limiting embodiments or aspects, step 306 may be performed at intervals. In some non-limiting embodiments or aspects, step 306 may be triggered by a transaction request message. In other non-limiting embodiments or aspects, the transaction request message received at step 304 may not trigger step 306, and step 304 may proceed directly to step 310, as an example.

As shown in FIG. 3, at step 308, process 300 may include determining if the entity querying the blockchain network at step 306 has permission to access profile data. For example, in embodiments in which the blockchain query is based on a key (e.g., such as a digital signature generated based on the requestor's private key), the key and/or digital signature based thereon may be used to prove that the requestor possesses a private key that identifies the requestor as a permitted user. In some non-limiting embodiments or aspects, a server, such as a transaction processing system or a node in the blockchain network, may issue a cryptographic challenge for the requestor to prove ownership of one or more keys. In some examples, step 308 may occur prior to obtaining any information from the blockchain network, such as profile data (e.g., profiles and/or pointer(s) to profiles). In some examples, step 308 may occur after obtaining one or more pointers from the blockchain network and before a network resource (e.g., such as a resource external to the blockchain network identified by a pointer) is accessed. If the requestor does not have permission, the method ends at step 316. In such a case, the interchange value may be determined based on predefined rules and/or values. The requestor may be a transaction processing system, merchant system, issuer system, acquirer system, third-party service provider, account holder, and/or any other party participating in an electronic payment processing network.

If permission to access the profile data (e.g., profile(s) and/or pointer(s) to profile(s)) is granted at step 308, the method proceeds to step 310 and the profile data is identified. For example, in non-limiting embodiments or aspects, in which the profile data on the blockchain network includes one or more pointers to one or more profiles, the pointers may be followed to obtain the profiles. In non-limiting embodiments or aspects, in which the profile(s) are stored on the blockchain network, the profiles may be obtained from the blockchain network through one or more blockchain transactions (e.g., including a cryptographic challenge and/or the like).

As shown in FIG. 3, at step 312, process 300 may include determining a dynamic interchange value based on the profile(s) obtained at step 310. For example, in some non-limiting embodiments or aspects, a dynamic interchange value is determined based on an account profile, account holder profile, and/or merchant profile. In some examples, a risk score for an account and/or account holder may be combined with a risk score for a merchant system and/or acquirer system based on one or more algorithms to result in a dynamic interchange value. In some examples, an offset (e.g., an increase or decrease) of a set interchange value may be determined.

As shown in FIG. 3, at step 314, process 300 may include processing the transaction with the dynamic interchange value. In some non-limiting embodiments, an authorization request message may be generated by the transaction processing system that includes, as a field of the message, the dynamic interchange value to represent the interchange fee that will be charged to process the transaction, and the authorization request message may be sent to the issuer system for approval. In some non-limiting embodiments, the transaction processing system may communicate the dynamic interchange value to the acquirer system and/or merchant system for approval before transmitting an authorization request message to the issuer system.

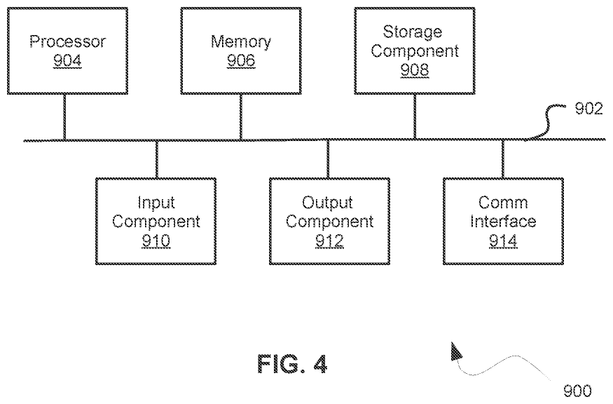

Referring now to FIG. 4, shown is a diagram of example components of a device 900 according to non-limiting embodiments. Device 900 may correspond to transaction processing system 100, profile generation engine 102, NFT generation engine 113, merchant system 112, and/or issuer system 109 of FIG. 1, as an example. Device 900 may also correspond to transaction processing system 202, blockchain network 200, and/or off-chain storage 220 of FIG. 2, as an example. In some non-limiting embodiments, such systems or devices may include at least one device 900 and/or at least one component of device 900. The number and arrangement of components shown are provided as an example. In some non-limiting embodiments, device 900 may include additional components, fewer components, different components, or differently arranged components than those shown. Additionally, or alternatively, a set of components (e.g., one or more components) of device 900 may perform one or more functions described as being performed by another set of components of device 900.

As shown in FIG. 4, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 4, storage component 908 may store information and/or software related to the operation and use of device 900. For example, storage component 908 may include a hard disk (e.g., a magnetic disk, an optical disk, a magneto-optic disk, a solid-state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A system comprising:
at least one processor configured to:
store account holder profile data for each account holder of a plurality of account holders at a unique blockchain address in a blockchain network;
store merchant profile data for each merchant of a plurality of merchants at a unique blockchain address in the blockchain network;
receive, from a merchant system associated with a first merchant, a transaction request message for a first transaction comprising an account identifier;
identify first account holder profile data from the account holder profile data stored in the blockchain network based on the account identifier;
identify first merchant profile data from the merchant profile data stored in the blockchain network based on the first merchant;
determine a dynamic interchange fee value based on the first merchant profile data and the first account holder profile data; and
process the first transaction based on the dynamic interchange fee value.

2. The system of claim 1, wherein the at least one processor is further configured to:
generate a non-fungible token for each account holder of the plurality of account holders, each non-fungible token for each account holder comprising the account holder profile data or a pointer to the account holder profile data for a corresponding account holder; and
generate a non-fungible token for each merchant of the plurality of merchants, each non-fungible token for each merchant comprising the merchant profile data or a pointer to the merchant profile data for a corresponding merchant.

3. The system of claim 1, wherein the at least one processor is further configured to generate a machine-readable code based on a non-fungible token for a first account holder associated with the first account holder profile data.

4. The system of claim 1, wherein the at least one processor is further configured to generate a machine-readable code based on a non-fungible token for the first merchant based on a merchant location identifier corresponding to the first merchant.

5. The system of claim 1, wherein the first account holder profile data and the first merchant profile data are identified before receiving the transaction request message, the at least one processor further configured to:
generate at least one database external to the blockchain network, the at least one database comprising the account holder profile data for the plurality of account holders and the merchant profile data for the plurality of merchants retrieved from the blockchain network; and
in response to receiving the transaction request message, query the at least one database based on the first merchant and the account identifier to obtain the first merchant profile data and the first account holder profile data.

6. The system of claim 1, wherein the first account holder profile data and the first merchant profile data are stored in at least one database arranged external to the blockchain network, wherein the account holder profile data stored in the blockchain network comprises pointers to the first account holder profile data and a second account holder profile data in the at least one database.

7. The system of claim 1, wherein the first merchant profile data comprises at least one of the following: a risk score for the first merchant, a risk score for an acquirer system corresponding to the first merchant, or any combination thereof.

8. The system of claim 1, wherein the first account holder profile data comprises at least one of the following: a risk score for a first account holder, a risk score for a first account, a risk score for an issuer system corresponding to the first account holder, a risk score for a credit union corresponding to the first account holder, or any combination thereof.

9. The system of claim 1, the at least one processor further configured to:
generate an authorization request message comprising the dynamic interchange fee value; and
communicate the authorization request message to an issuer system corresponding to a first account holder associated with the first account holder profile data.

10. A method comprising:
storing account holder profile data for each account holder of a plurality of account holders at a unique blockchain address in a blockchain network;
storing merchant profile data for each merchant of a plurality of merchants at a unique blockchain address in the blockchain network;
receiving, from a merchant system associated with a first merchant, a transaction request message for a first transaction comprising an account identifier;
identifying, with at least one processor, first account holder profile data from the account holder profile data stored in the blockchain network based on the account identifier;
identifying, with at least one processor, first merchant profile data from the merchant profile data stored in the blockchain network based on the first merchant;
determining, with at least one processor, a dynamic interchange fee value based on the first merchant profile data and the first account holder profile data; and
processing, with at least one processor, the first transaction based on the dynamic interchange fee value.

11. The method of claim 10, further comprising:
generating a non-fungible token for each account holder of the plurality of account holders, each non-fungible token for each account holder comprising the account holder profile data or a pointer to the account holder profile data for a corresponding account holder; and
generating a non-fungible token for each merchant of the plurality of merchants, each non-fungible token for each merchant comprising the merchant profile data or a pointer to the merchant profile data for a corresponding merchant.

12. The method of claim 10, further comprising generating a machine-readable code based on a non-fungible token for a first account holder associated with the first account holder profile data.

13. The method of claim 10, further comprising generating a machine-readable code based on a non-fungible token for the first merchant based on a merchant location identifier corresponding to the first merchant.

14. The method of claim 10, wherein the first account holder profile data and the first merchant profile data are identified before receiving the transaction request message, the method further comprising:
generating at least one database external to the blockchain network, the at least one database comprising the account holder profile data for the plurality of account holders and the merchant profile data for the plurality of merchants retrieved from the blockchain network; and
in response to receiving the transaction request message, querying the at least one database based on the first merchant and the account identifier to obtain the first merchant profile data and the first account holder profile data.

15. The method of claim 10, wherein the first account holder profile data and the first merchant profile data are stored in at least one database arranged external to the blockchain network, wherein the account holder profile data stored in the blockchain network comprises pointers to the first account holder profile data and a second account holder profile data in the at least one database.

16. The method of claim 10, wherein the first merchant profile data comprises at least one of the following: a risk score for the first merchant, a risk score for an acquirer system corresponding to the first merchant, or any combination thereof.

17. The method of claim 10, wherein the first account holder profile data comprises at least one of the following: a risk score for a first account holder, a risk score for a first account, a risk score for an issuer system corresponding to a first account holder, a risk score for a credit union corresponding to the first account holder, or any combination thereof.

18. The method of claim 10, further comprising:
generating an authorization request message comprising the dynamic interchange fee value; and
communicating the authorization request message to an issuer system corresponding to a first account holder associated with the first account holder profile data.

19. A computer program product comprising at least one non-transitory computer-readable medium including program instructions that, when executed by at least one processor, cause the at least one processor to:
store account holder profile data for each account holder of a plurality of account holders at a unique blockchain address in a blockchain network;
store merchant profile data for each merchant of a plurality of merchants at a unique blockchain address in the blockchain network;
receive, from a merchant system associated with a first merchant, a transaction request message for a first transaction comprising an account identifier;
identify first account holder profile data from the account holder profile data stored in the blockchain network based on the account identifier;
identify first merchant profile data from the merchant profile data stored in the blockchain network based on the first merchant;
determine a dynamic interchange fee value based on the first merchant profile data and the first account holder profile data; and
process the first transaction based on the dynamic interchange fee value.

20. The computer program product of claim 19, wherein the program instructions further cause the at least one processor to:
generate a non-fungible token for each account holder of the plurality of account holders, each non-fungible token for each account holder comprising the account holder profile data or a pointer to the account holder profile data for a corresponding account holder; and
generate a non-fungible token for each merchant of the plurality of merchants, each non-fungible token for each merchant comprising the merchant profile data or a pointer to the merchant profile data for a corresponding merchant.
